(19) United States
(12) Patent Application Publication
(10) Pub. No.: US 2008/0282297 A1
(43) Pub. Date: Nov. 13, 2008

(54) SYSTEM AND METHOD FOR PROVIDING ADDITIONAL INFORMATION USING BI-DIRECTIONAL BROADCASTING SERVICE

(75) Inventor: Jae Yeon Park, Daejeon (KR)

Correspondence Address: LEXYOUME IP GROUP, LLC, 5180 PARKSTONE DRIVE, SUITE 175, CHANTILLY, VA, 20151, US

(73) Assignee: KT CORPORATION, SUNGNAM-SI (KR)

(21) Appl. No.: 12/057,232

(22) Filed: Mar. 27, 2008

Related U.S. Application Data
(63) Continuation of application No. PCT/KR2006/003838, filed on Sep. 27, 2006.

(30) Foreign Application Priority Data
Sep. 27, 2005 (KR) 10-2005-0090045

(51) Int. Cl. H04N 7/173

(52) U.S. Cl. 725/86; 725/105

(57) ABSTRACT

Disclosed is a system for providing additional information using a bi-directional broadcasting service and a method for the same. The system provides additional information using a bi-directional broadcasting service, after the additional information provided through the bi-directional broadcasting service is book-marked, and is capable of providing the book-marked additional information through wired/wireless communications when a user wants.

### CROSS-REFERENCE TO RELATED PATENT APPLICATIONS

This application is a continuation application under 35 U.S.C. § 365(c) of International Application No. PCT/KR2006/003838, filed Sep. 27, 2006 designating the United States. International Application No. PCT/KR2006/003838 was published in English as WO2007/037615 A1 on Apr. 5, 2007. This application further claims the benefit of the earlier filing date under 35 U.S.C. § 365(b) of Korean Patent Application No. 10-2005-0090045 filed Sep. 27, 2005. This application incorporates herein by reference the International Application No. PCT/KR2006/003838 including the International Publication No. WO2007/037615 A1 and the Korean Patent Application No. 10-2005-0090045 in their entirety.

### BACKGROUND

1. Field

The present disclosure relates to a method of providing information using a bi-directional broadcasting service, and more particularly, to a method of additional information using a bi-directional broadcasting service per a user's request.

2. Discussion of the Related Technology

Recently, broadcasting circumstances have been changed according to development of the technology and demand changes of viewers. That is, an analog broadcasting is changed into a digital broadcasting; broadcasting medium is diversified due to a development from a terrestrial wave to a cable, a satellite or the like; a bi-directionality is provided together through a communication network; the broadcasting terminals become further intelligent; and, therefore, the recent broadcasting circumstances have been suffered more severe changes than any other fields.

As an interactive television service means a service capable of receiving digital multimedia contents such as a game, an education, life information or the like through a television, the viewers can use various services such as the game, additional information, a shopping or the like by only a simple remote controller operation.

Generally, the television for watching the bi-directional broadcasting is called as various concepts such as a smart television, an enhanced television, an intelligent television, Internet television or the like. Theoretically, the interactive television is a television that the viewer can control by himself when the viewer watches and what the viewer watches; and, functionally, the interactive television means that a television unifies the Internet service, the data broadcasting service and a personal video recorder (PVR) functions except for the typical broadcasting.

On the other hand, the interactive television service does not transmit the program one-directionally from the broadcasting station as a typical broadcasting, but it allows the viewer and the broadcasting station to perform an interaction therebetween. In order to this, the broadcasting station additionally manufactures the contents implementing the bi-directional function except for the program to transmit the manufactured contents to the viewer. The viewer can represent the decision through a return channel.

The interactive television service can be greatly classified into two types as follows.

First, the first service type is a type to mainly supply additional information related to the program, it is referred to as an enhanced service which has a characteristic improved in comparison with typical television broadcasting. Since this service type was cooperated with the program, the service has provided to the same channel. That is, the additional information is transmitted by using a marginal frequency bandwidth in a frequency bandwidth(channel) allocated for a program transmission(in case of ATSC method, information of 19.3 Mbps can be transmitted with a bandwidth 6 MHz; whereas, since a bandwidth of 15˜18 Mbps was required for transmitting a high definition(HD) program, information of 1.3˜4.3 Mbps can be additionally transmitted), more detailed description of the information related to a program actor and the photographing place, the information of a player and a score of a sports game, and an advertisement may be a major example.

Like this, in case when the additional information is provided by using the channel equal to a program, the program is converted into the bi-directional service screen by pushing a bidirectional service button of a remote controller during watching the program and a bi-directional service menu capable of selecting the additional information is outputted on a marginal space which is generated with decreasing a size of the screen of an originally watched program. At this time, if a desired menu is selected by using a directional button or a number button of the remote controller, the corresponding information can be utilized.

The second service type provides information regardless of the program, it can use a marginal frequency bandwidth of a frequency bandwidth (channel) allocated for transmitting the program like the enhanced channel case, but to use an additional frequency bandwidth (channel) has been used generally since it did not depend on the program. In this result, this service type has referred to as a virtual channel, since the viewer was selected an additional channel to use the selected additional channel, it can be operated as a pay channel for the subscribers. Main examples are an information providing service such as news, life information, weather forecast or the like, an electronic commerce such as a home shopping, a stock exchange or the like, a communication service such as TV-mail, chatting or the like, and an electronic program guide (EPG) service or the like.

Like this, in case when the additional information is provided by using a channel independent of the program, if the desired menu is selected by changing the channel through the remote controller, the corresponding information can be used.

The foregoing discussion is to provide general background information, and does not constitute an admission of prior art.

### SUMMARY

An aspect of the present invention provides a system for providing additional information using a bi-directional broadcasting service, after the additional information such as shopping, journey, games or the like provided through the bi-directional broadcasting service is book-marked, capable of providing the book-marked additional information through the wired/wireless communications when a user wants and a method thereof.

Other aspects and advantages of the present invention will be described in detail hereinafter and they are known by the embodiments of the present invention. And also, the aspects and the advantages of the present invention will be realized by means and combinations represented at the accompanying claims.

In accordance with one aspect of the present invention, there is provided a system for providing additional information using a bidirectional broadcasting service capable of providing book-marked additional information supplied from the bi-directional broadcasting service capable of providing book-marked additional information when a user wants, the system including: interface means for providing an interface with a wired/wireless user terminal; a user information database for storing user information required for authenticating the user and information for the wired/wireless user terminal to receive the service; a bookmark information database for storing bookmark information requested by the user through the wired/wireless user terminal; bookmark managing means for storing bookmark request information on the bookmark information database, after the user is authenticated with reference to the user information database as a bookmark of a specific additional information is requested from the wired/wireless user terminal watching the bi-directional broadcasting through the interface means; and additional information providing means for transmitting corresponding additional information by fabricating the corresponding additional information in a shape capable of being used in the wired/wireless user terminal, after the user is authenticated with reference to the user information database as the additional information bookmarked from the wired/wireless user terminal is requested through the interface means.

In accordance with another aspect of the present invention, there is provided a method for providing additional information using a bi-r-directional broadcast service capable of providing the bookmarked additional information when a user wants, the method including the steps of: bookmark requesting step of receiving a request for the bookmark of specific additional information from the wired/wireless user terminal watching a bidirectional broadcast; bookmark managing step of storing a bookmark requesting information from the wired/wireless user terminal and managing the stored bookmark requesting information; additional information requesting step of receiving additional information bookmarked from the wired/wireless user terminal; and additional information providing step of fabricating the requested corresponding additional information in a shape capable of using in the wired/wireless user terminal to transmit the fabricated additional information.

As described above, embodiments of the present invention has an advantage that a user can use necessary additional information regardless of a broadcasting time by providing bookmarked additional information through wired/wireless communication when the user wants after the additional information using the bi-directional broadcasting service is bookmarked.

And also, embodiments of the present invention has an advantage that additional information differentiated so as to meet a status of the user can be provided the location based indiscriminate additional information not general additional information supplied such as advertisement by providing the additional information on the basis of location according to the selection of the user.

### BRIEF DESCRIPTION OF THE DRAWINGS

These and other features, aspects, and advantages of embodiments of the present invention will be more fully described in the following detailed description, taken accompanying drawings. In the drawings:

FIG. 1 shows a construction diagram of a bi-directional broadcasting service system according to one embodiment of the present invention;

FIG. 2 is a construction diagram showing an additional information providing apparatus using the bidirectional broadcasting service system according to one embodiment of the present invention;

FIG. 3 is a flow chart illustrating a method for providing the additional information using the bi-directional broadcasting service according to one embodiment of the present invention; and

FIG. 4 represents a flow chart showing a method for providing additional information using a bi-directional broadcasting service according to one embodiment of the present invention.

### DETAILED DESCRIPTION OF EMBODIMENTS

Hereinafter, embodiments of the present invention will be described in detail with reference to the accompanying drawings. It should be noted that all flow charts can substantially represent medium capable of being read by a computer and can represent various processes performed by a computer or a processor regardless of a status that the computer or the processor is clearly shown or not.

In the claims of the present invention, construction elements represented as means for performing a function described in the detailed description are intended to include, for example, all methods for performing functions including all types of software including combinations of circuit devices performing functions or firmware/micro code or the like, and they are combined with appropriate circuits to implement the software to perform the functions. Since the present invention defined by such claims is combined with functions supplied by the means variously explained and combined with methods required by the claims, it should be understood that any means capable of supplying the functions are equivalent to those understood from the present specification.

In a bi-directional broadcasting service, there may be a shortcoming that the additional information provided from the bidirectional broadcasting service can be used during watching the program. That is, since the additional information provided from the bi-directional broadcasting service has a characteristic that it is provided by broadcasting during a predetermined time, if a limited time passes, there is a problem that the user has a difficulty for accessing to the additional information. Therefore, it is sincerely required for a method capable of receiving the shopping information, the journey information, the game or the like provided during watching the program thereafter when the user wants.

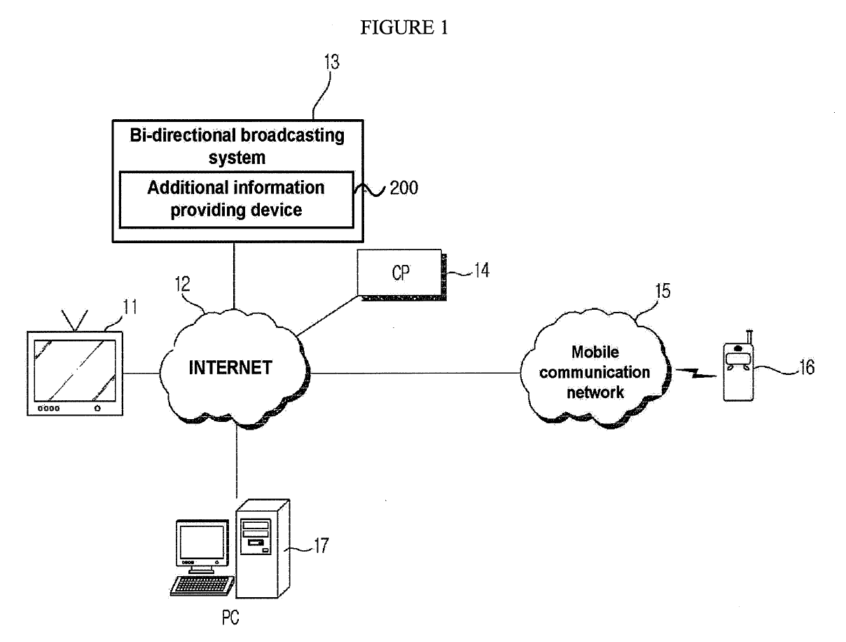

FIG. 1 shows a construction diagram of a bidirectional broadcasting service system according to one embodiment of the present invention.

As shown in FIG. 1, a bi-directional broadcasting service system according to one embodiment of the present invention includes an interactive television 11, the Internet 12, a bi-directional broadcasting system 13, a content provider(CP) 14, a mobile communication network 15 and a mobile communication terminal 16.

The interactive television 11 includes a general digital television and a set top box as a device for using the bi-directional broadcasting service. The interactive television 11 receives the broadcasting contents from the bi-directional broadcasting system 13 to output the received broadcast contents and transmits a user response signal inputted through a remote controller to the bi-directional broadcasting system 13 through a return channel.

The Internet 12 transmits the broadcasting contents provided from the bi- directional broadcasting system 13 to the user terminals, i.e., the interactive television 11, the personal computer 17 and the mobile communication terminal 16 or the like, can use a cable network, a data communication network or the like in place of the Internet 12 as a digital data network for transmitting the response signal from the user terminal to the bidirectional broadcasting system 13.

The bi-directional broadcasting system 13 is composed of a storage server for storing the broadcasting contents, a control server for transmitting the broadcasting contents to the user terminal, i.e., the interactive television 11, the personal computer 17, the mobile communication terminal 16 or the like, and for processing the user response signal, e.g., a bookmark request signal or the like, inputted from the return channel, and a switching device for distributing the broadcasting contents. Herein, the control server includes an additional information providing device 200 for providing the additional information to the wired/wireless terminal by cooperating with the bidirectional broadcasting service according to an embodiment of the present invention.

That is, the bi-directional broadcasting system 13 manages the contents and the electronic programming guide(EPG) provided from the content provider 14 and provides broadcasting/recording/reproducing services by distributing the contents to a place adjacent to a subscriber through a content delivery network(CDN). At this time, in the contents provided from the content provider 14, the additional information related to the contents and the EPG related to the additional information can be included.

For example, the additional information to be provided together with a drama can be information related to a photographing place, a method for going to the photographing place, a characteristic of the photographing place, information of a leading actor, another drama/cinema that the leading actor appears in the play or the like. And, in case of a sport program, information related to a rule of the sport, information related to players and coaches, information related to a method for going to a sport stadium or the like can be provided as the additional information.

And also, the bi-directional broadcasting system 13 can supply sale information such as clothes or glasses wearing the leading actor of the drama, accessories or the like as shopping information and can perform the purchase and settlement caused by the leading actor.

Although the additional information in embodiments of the present invention can be contents it self as a concept including the shopping information, the detailed information, the journey information, the game or the like supplied through together with the broadcasting program or another channel, it can also be connection information, e.g., a shopping mall URL, a journey information URL, a game URL or the like, capable of being connected to a site for providing the contents.

On the other hand, the additional information providing device 200 acquires information related to the additional information bookmarked by the user through the interactive television 11 by analyzing the user response signal received through the return channel. And, the additional information providing device 200 transmits the additional information bookmarked by the user according to the request from the user to the wired/wireless terminal, i.e., the interactive television 11, the personal computer 17, the mobile communication terminal 16 or the like, cooperating with the content provider 14. Herein, the additional information providing device 200 provides the additional information bookmarked by the user through the interactive television 11 in batch, extracts the corresponding additional information on the basis of a location of the user to provide the extract additional information or automatically provides when the event set by the user occurs.

If the user requests that the journey information previously bookmarked through the interactive television 11 is received to the mobile communication terminal 16, the additional information providing device 200 finds the location of the mobile communication terminal 16 and transmits the journey information related to this.

Also, if the user requests the shopping information previously bookmarked through the interactive television 11, the shopping is performed by transmitting the related shopping information.

The content provider 14 supplies various broadcasting program including the additional information and the EPG(Electronic Programming Guide) to the bi-directional broadcasting system 13.

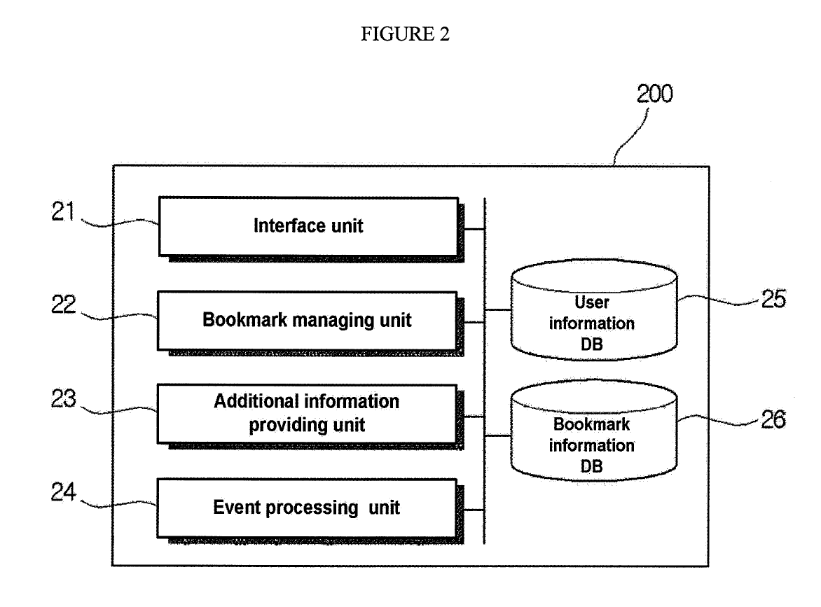

Hereinafter, the detailed construction of the additional information providing device 200 and the operational process thereof will be described with reference to FIG. 2.

FIG. 2 is a construction diagram showing an additional information providing apparatus using the bi-directional broadcasting service system according to one embodiment of the present invention.

As shown in FIG. 2, the additional information providing device 200 using the bidirectional broadcasting service according to one embodiment of the present invention includes an interface unit 21, a bookmark managing unit 22, an additional information providing unit 23, an event processing unit 24, a user information database 25 and a bookmark information database 26.

The interface unit 21 supplies the user terminal, i.e., the interactive television 11, the personal computer 17, the mobile communication terminal 16 or the like, and an input/output(request/response) interface. That is, the interface unit 21 receives the bookmark request related to specific additional information from the interactive television 11 to transmit the received bookmark request to the bookmark managing unit 22; and, thereafter, the corresponding additional information is supplied to the user terminal, i.e., the interactive television 11, the personal computer 17, the mobile communication terminal 16 or the like, by transmitting the supplying request of the bookmark additional information from the user terminal to the additional information providing unit 23. It should be noted that the interface with such user terminal 11 is implemented together with the bidirectional broadcasting system 13 which the mobile content providing device belongs or connects thereto.

After the bookmark managing unit 22 authenticates the user with reference to the user information database 25 according to the bookmark request for the specific additional information received through the interface unit 21, it stores the authenticated result on the bookmark information database. At this time, the user can simply bookmark the additional information; and then, can set for a method of receiving the bookmarked information. For example, the service providing can be requested on the basis of the location and the service providing time can be reserved.

And also, the bookmark managing unit 22 can manage the bookmark requested from the user according to each category.

After the additional information providing unit 23 authenticates the user with reference to the user information database 25 according to the bookmark information request received through the interface unit 21, and the bookmark list corresponding to the user from the bookmark information database 26 is extracted, and then, the additional information providing unit 23 receives the specific additional information being selected by the user by providing the extracted result to the user. And, the selected additional information is fabricated in a shape capable of using at the user terminal, i.e., the interactive television 11, the personal computer 17, the mobile communication terminal 16 or the like, to transmit the fabricated additional information. As described above, the additional information transmitted to the user terminal can be the contents itself or can be the connection information such as URL capable of receiving the contents.

Also, the additional information providing unit 23 can push the corresponding additional information to the user terminal together with the event processing unit 24 even though the request of the user does not exist according to the service providing method set by the user.

For example, if the user requests the location based service related to the specific additional information, it pushes the additional information, e.g., the journey information, the restaurant information, the facility information, the navigation information or the like, corresponding to the location of the mobile communication terminal 16 registered by the user to the mobile communication terminals 16.

For another example, if the user reserves the service providing time for the specific additional information, the additional information providing unit 23 pushes the corresponding additional information, e.g., the shopping information, the journey information, the health information, the learning information or the like, to the user terminal, e.g., the interactive television 11, the personal computer 17, the mobile communication terminal 16 or the like, according to the control of the event processing unit 24. Although such reservation transmission service can be realized for each reservation one time, it can be repeatedly implemented by a specific time every day or a specific day of the week according to the selection of the user.

The event processing unit 24 monitors whether the reservation service providing time related to the additional information bookmarked by the user arrives or not, and performs a function of alarming the monitored result to the additional information providing unit 23.

The user information database 25 stores the user information required for the user authentication and user terminal information, e.g., an Internet Protocol(IP) address of the interactive television 11, an IP address allocated to the personal computer 17, a telephone number of the mobile telecommunication terminal or the like, related to the user terminal to receive the to receive the additional information.

The bookmark information database 26 stores the bookmark information related to various additional information requested by the user according to the control of the bookmark managing unit 22.

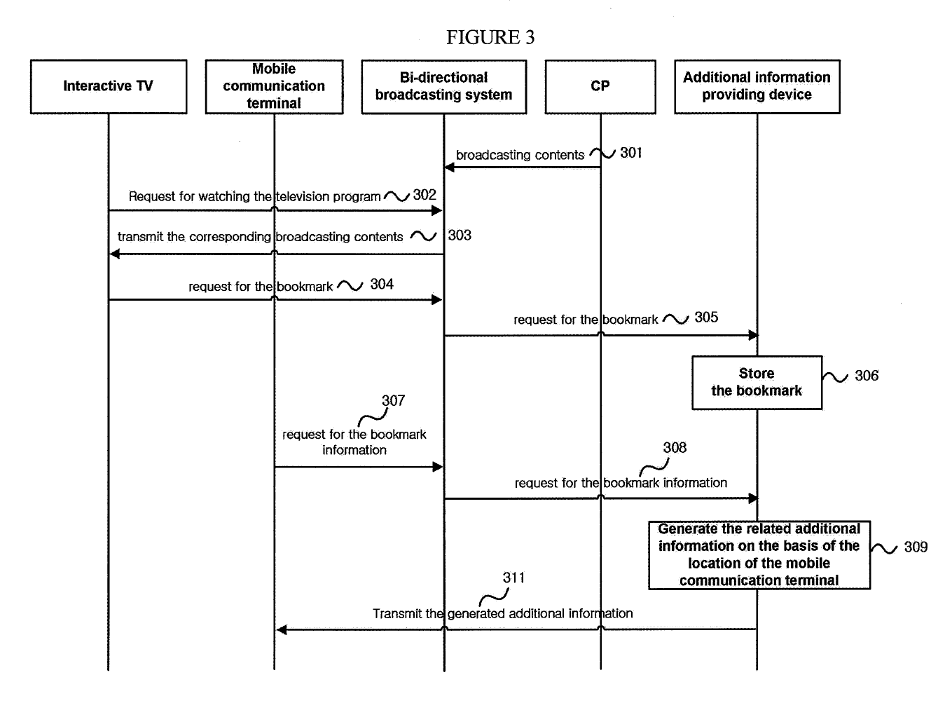

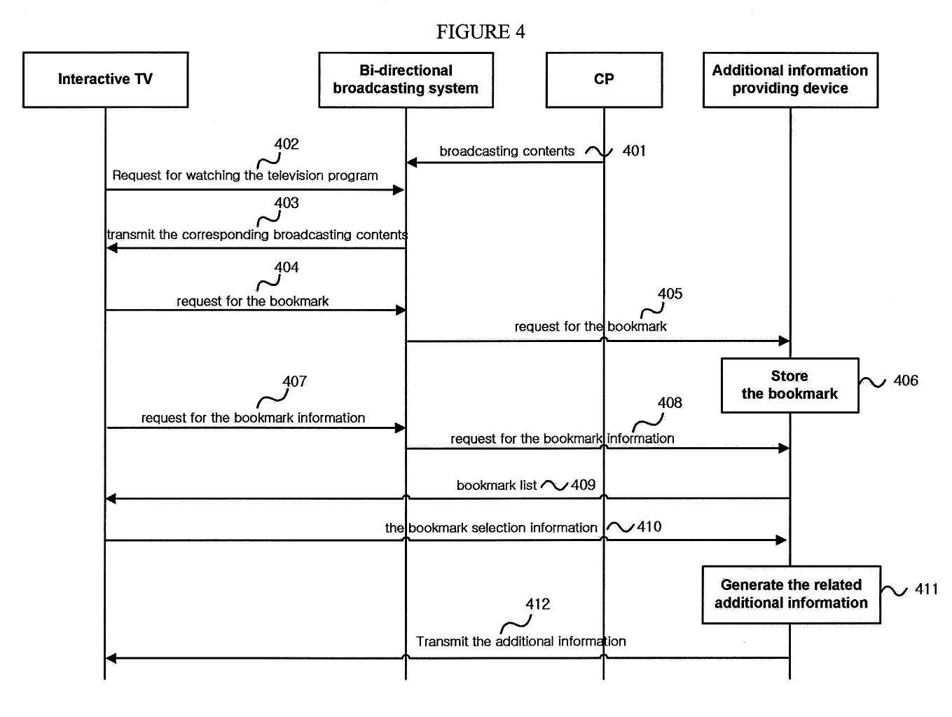

Hereinafter, embodiments of the present invention will be described in detail with reference to FIG. 3 and FIG. 4.

FIG. 3 is a flow chart illustrating a method for providing the additional information using the bidirectional broadcasting service according to one embodiment of the present invention, wherein a process of receiving the service for the additional information bookmarked by the user on the basis of a location by using the mobile communication terminal 16.

First, the bi-directional broadcasting system 13 receives the broadcasting contents from the content provider 14 and the EPG for the same and stores the received broadcasting contents and the received EPG(step 301). At this time, the additional information can be added into the broadcasting contents or the broadcast contents itself can be contents for the data broadcasting.

On the other hand, if the bidirectional broadcasting system 13 receives the request for watching the television program from the interactive television 11(step 302), the corresponding broadcasting contents are transmitted to the interactive television 11 (step 303). And, the bidirectional broadcasting system is received a request for the bookmark of the specific additional information received from the interactive television 11 while watching the television programs is received(step 304).

Then, the bi-directional broadcasting system 13 transmits the bookmark request from the interactive television 11 to the additional information providing device 200 (step 305). The additional information providing device 200 stores the transmitted bookmark request on the database managed by itself (step 306). At this time, if the additional information bookmarked by the user assumes as the journey information, the bookmarked additional information is assumed that it is requested for receiving the service on the basis of the location.

Thereafter, after the user connects to the bi-directional broadcasting system 13 by using the mobile communication terminal 16, the additional information bookmarked by the user is requested by using the EPG provided from the bi-directional broadcasting system 13 (step 307).

And then, the bi-directional broadcasting system 13 transmits the request from the user to the additional information providing device 200 (step 308), the additional information providing device 200 generates the related additional information on the basis of the location of the mobile communication terminal 16 (step 309) and transmits the generated additional information to the mobile communication terminal 16 over the mobile communication network 15 (step 310).

Herein, if the additional information bookmarked by the user is the journey information, the additional information transmitted to the mobile communication terminal 16 may be the journey information related to a place where the mobile communication terminal 16 is currently located. If the additional information bookmarked by the user is information related to the restaurant, the additional information transmitted to the mobile communication terminal 16 may be the information fro the recommendable restaurant at the place where the current mobile communication terminal 16 is located.

Also, if the additional information bookmarked by the user are several numbers, the additional information providing device 200 generates the bookmark list corresponding to the user by searching the database managed by the additional information providing device 200 and transmits the generated bookmark list to the interactive television 11, and receives the specific bookmark selected from the user by this result. And, the additional information providing device 200 is generated the additional information corresponding to the received bookmark being selected to transmit the additional information to the interactive television 11.

Like this, the user can receive the additional information bookmarked on the basis of the location by using the mobile communication terminal 16 in case of need during watching the television.

FIG. 4 represents a flow chart showing a method for providing additional information using a bi-directional broadcasting service according to one embodiment of the present invention, wherein a process of receiving the service for the additional information bookmarked by the user by using the interactive television 11.

First, the bi-directional broadcasting system 13 receives the broadcast contents from the content provider 14 and the EPG for the same to store the received the broadcast contents and the EPG (step 401). At this time, the additional information can be included into the broadcast contents and the broadcast contents itself can be the contents for the data broadcasting.

On the other hand, if the bi-directional broadcasting system 13 receives the request for watching the television program from the interactive television 11 (step 402), the corresponding broadcasting contents are transmitted to the interactive television 11 (step 403). And, a request for the specific additional information is received from the interactive television 11 during watching the television program (step 404).

Then, the bi-directional broadcasting system 13 transmits the bookmark request from the interactive television 11 to the additional information providing device 200 (step 405), and the additional information providing device 200 stores the transmitted bookmark request on the database managed by itself (step 406). At this time, the additional information bookmarked by the user assumes as the shopping information.

Thereafter, the user requests the additional information bookmarked by the user by using the EPG supplied from the bi-directional broadcasting system 13 through the interactive television 11 (step 407). Then, the bi-directional broadcasting system 13 transmits the request from the user to the additional information providing device 200 (step 408). The additional information providing device 200 generates the bookmark list corresponding to the user by searching the database managed by itself to transmit the generated bookmark list to the interactive television 11 (step 409).

And, if the user selects the specific bookmark among the bookmark list through the interactive television 11, the selected information is transmitted to the additional information providing device 200 through the bi-directional broadcasting system 13 (step 410).

Then, the additional information providing device 200 generates the additional information corresponding to the selectively received bookmark (step 411) to transmit the generated additional information to the interactive television 11 (step 412). At this time, if the additional information transmitted to the interactive television 11 is the shopping information, the additional information transmitted to the interactive television 11 can be connection information(URL) of Internet shopping mall capable of purchasing arbitrary goods. The user can purchase the goods by using the received additional information such as the connection information(URL) of the Internet shopping mall.

Also, the additional information providing device 200 supplies the additional information related to the shopping to the interactive television 11 representing on the Internet shopping mall and it carries out the purchase and settlement thereof.

While embodiments of the present invention has been described, it will be apparent to those skilled in the art that various changes and modifications may be made without departing from the scope of the invention as defined in the following claims.

What is claimed is:

1. A system for providing additional information using a bidirectional broadcasting service capable of providing bookmarked additional information when a user wants, the system comprising:
interface means for providing an interface with a wired/wireless user terminal;
a user information database for storing user information required for authenticating the user and information for the wired/wireless user terminal to receive the service;
a bookmark information database for storing bookmark information requested by the user through the wired/wireless user terminal;
bookmark managing means for, as a request for making a bookmark of a specific additional information is received from the wired/wireless user terminal watching the bi-directional broadcasting service through the interface means, storing the bookmark of the specific additional information requested by the user on said bookmark information database, after the user is authenticated with reference to said user information database; and
additional information providing means for, as receiving a request for the specific additional information bookmarked from the wired/wireless user terminal through the interface means, transmitting the specific additional information by fabricating the specific additional information in a shape capable of being used in the wired/wireless user terminal, after the user is authenticated with reference to said user information database.

2. The system as recited in claim 1, wherein, as a location based service for the specific additional information bookmarked from the wired/wireless user terminal is requested through the interface means, the additional information providing means further performs a function of transmitting the specific additional information corresponding to a current location of the user after fabricating the specific additional information in a shape capable of using at the wired/wireless user terminal.

3. The system as recited in claim 1, wherein the bookmark managing means further performs a function of, as receiving from the wired/wireless user terminal a reservation request for transmitting the specific additional information bookmarked to the wired/wireless user terminal at a service providing time, recording the reservation request and the service providing time inputted from the wired/wireless user terminal on the bookmark information database; and
further includes event processing means for monitoring whether the service providing time reserved for the specific additional information bookmarked by the user arrives or not and for informing the additional information providing means of the monitored result in order for additional information providing means to transmit the specific additional information to the wired/wireless user terminal.

4. The system as recited in claim 1, wherein the bookmark managing means manages the request for making the bookmark of the specific additional information from the user by classifying the same according to each category.

5. The system as recited in claim 1, wherein, after the user is authenticated with reference to the user information database as a request for the bookmark is received from the wired/wireless user terminal through the interface means, the additional information providing means transmits a bookmark list corresponding to the user extracted from the bookmark information database to the wired/wireless user terminal and, when the user selects a specific additional information, fabricates the specific additional information in a shape capable of using in the wired/wireless user terminal and transmits the specific additional information to the wired/wireless user terminal.

6. The system as recited in claim 5, wherein the specific additional information transmitted to the wired/wireless user terminal is contents capable of using at the wired/wireless user terminal.

7. The system as recited in claim 5, wherein the specific additional information transmitted to the wired/wireless user terminal is connection information (URL) to receive the contents capable of using in the wired/wireless user terminal.

8. The system as recited in claim 1, wherein the wired/wireless user terminal is any one of an interactive television, a computer or a mobile communication terminal.

9. A method for providing additional information using a bi-directional broadcasting service capable of providing the book-marked additional information when a user wants, the method comprising:
bookmark requesting step of receiving a request for a bookmark of specific additional information from a wired/wireless user terminal watching bi-directional broadcast service;
bookmark managing step of storing and managing the request for the bookmark of specific additional information from the wired/wireless user terminal;
additional information requesting step of receiving a request for said specific additional information bookmarked from the wired/wireless user terminal; and
additional information providing step of fabricating the requested specific additional information in a shape capable of using in the wired/wireless user terminal and transmitting the fabricated specific additional information to the wired/wireless user terminal.

10. The method as recited in claim 9, further comprising:
location based service providing step of, as receiving from the wired/wireless user terminal a request for a location based service related to the specific additional information bookmarked, fabricating the specific additional information corresponding to a current location of the user in a shape capable of using in the wired/wireless user terminal and transmitting the fabricated specific additional information to the wired/wireless user terminal.

11. The method as recited in claim 10, further comprising;
reservation service providing step of, as receiving from the wired/wireless user terminal a reservation request for transmitting the specific additional information bookmarked to the wired/wireless user terminal at a specific time, recording the reservation request and transmitting the corresponding specific additional information to the wired/wireless user terminal at the specific time.

12. The method as recited in claim 9, wherein the bookmark managing step manages the request for the bookmark of specific additional information transmitted from the user by classifying the same into each category.

13. The method as recited in claim 9, wherein, the additional information providing means extracts a bookmark list corresponding to the user from the bookmark information database and transmits the bookmark list corresponding to the user to the wired/wireless user terminal and, when the user selects a specific additional information, fabricates the specific additional information in a shape capable of using in the wired/wireless user terminal and transmits the specific additional information to the wired/wireless user terminal.

14. The method as recited in claim 13, wherein the specific additional information transmitted to the wired/wireless user terminal is contents capable of using in the wired/wireless user terminal.

15. The method as recited in claim 13, wherein the specific additional information transmitted to the wired/wireless user terminal is connection information (URL) to receive contents capable of using at the wired/wireless user terminal.

16. The method as recited in claim 9, wherein the wired/wireless user terminal is any one of an interactive television, a computer or a mobile telecommunication terminal.
